(19) United States
(12) Patent Application Publication
(10) Pub. No.: US 2004/0085379 A1
(43) Pub. Date: May 6, 2004

(54) Self-contained printing device diagnostics

(76) Inventors: Matthew Taylor, Meridian, ID (US); Ryan Christensen, Meridian, ID (US); Ryan Jamison, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/287,223

(22) Filed: Nov. 4, 2002

(51) Int. Cl. B41J 29/393

(52) U.S. Cl. 347/19

(57) ABSTRACT

A tester print head has at least one conductive pad that is coupled to a status return pad by circuitry. The tester print head is inserted into a printer carriage assembly that is linked to printer control circuitry through linking hardware. A self-test signal is applied to the linking hardware. If the tester print head provides an indication to the control circuitry that the self-test signal was received, the linking hardware passed the self-test. If the indication is not provided to the control circuitry, the self-test failed and the functional print head that was replaced by the tester print head may be operating properly.

### FIELD OF THE INVENTION

The present invention relates generally to printing device diagnostics.

### BACKGROUND

A typical inkjet printing device has at least one pen or print head that reciprocates over a printable surface such as a sheet of paper. The print head includes an array of numerous orifices through which droplets of ink are expelled onto the surface of a paper to generate a desired pattern. Color inkjet printing devices generally have either a multi-chamber cartridge or multiple print heads, each print head containing a different color of ink.

Typically, each print head is comprised of electronics that can communicate information about the contents of the print head to a computer that is coupled to the printing device. This information may include the manufactured date, ink color, and/or the quantity of ink in the print head.

Warranty and/or maintenance service calls to fix such a printing device can be expensive for the device manufacturer. The manufacturer typically sends a skilled repairperson to visit a customer and diagnose device problems. Additionally, the customer may not be able to use the printer until the service call is made, which is inconvenient and could be expensive for the customer. Some of these printing problems may simply be a malfunctioning print head or other simple problems that the customer could have fixed themselves if they had the diagnostic capabilities to determine the problem.

For the reason stated above, and for other reasons stated below that will become apparent to those skilled in the art upon reading and understanding the present specification, there is a need in the art for improved printing device self-diagnostics.

### SUMMARY

The embodiments of the present invention encompass a self-test print head for use in a printing device. The print head is comprised of at least one conductive pad capable of accepting a self-test signal from the printer through linking hardware. In one embodiment, the self-test signal is generated by the printer's control circuit. A feedback path couples a return status pad on the print head to the conductive pad. If the linking hardware is open or shorted, the self-test signal will not be coupled to the conductive pad and, therefore, will not be returned to the control circuit through the feedback path and return status pad. The presence of the self-test signal indicates that a print failure may be the print head. The absence of the self-test signal indicates that a print failure may be linking hardware. Further embodiments of the invention include methods and apparatus of varying scope.

### DESCRIPTION OF THE DRAWINGS

FIG. 1 is a block diagram of a tester print head in accordance with one embodiment of the present invention.

FIG. 2 is a circuit diagram of the circuitry of the tester print head in accordance with one embodiment of the present invention.

FIG. 3 is a perspective view of the testing print head in accordance with one embodiment of the present invention.

FIG. 4 is a print head carriage assembly in accordance with one embodiment of the present invention.

FIG. 5 is a block diagram of a printer in accordance with one embodiment of the present invention.

FIG. 6 is a flowchart of a self-test method in accordance with one embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

The subsequent discussion of the present invention refers to a printer as being an embodiment of use of the testing print head. However, any reference to a printer encompasses any device that has a printing function such as facsimile machines or any combination unit incorporating a print function.

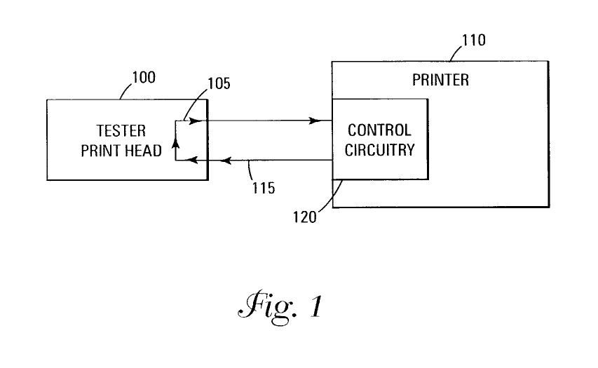

FIG. 1 illustrates a block diagram of one embodiment of a tester print head (100) of the present invention as used with a typical printer (110) or printing device. The tester print head (110) includes at least one feedback path (105) that routes self-test signals from the printer control circuitry (120) through the tester print head (100) and back to the control circuitry (120). The signals are carried through the printer's cables, connections, and other linking hardware (115) in order to check continuity or for shorting of the hardware.

In one embodiment, the feedback path (105) illustrated in FIG. 1 encompasses multiple feedback paths (105) incorporated into the tester print head (100). In such an embodiment, a separate feedback path (105) is used for each connection from the printer control circuitry (120) to the tester print head (100). This enables the tester print head (100) to test each connection for continuity or shorting. For example, depending on the printer embodiment, the print head may have connections for firing a certain print head nozzle or determining an ink level in a print head.

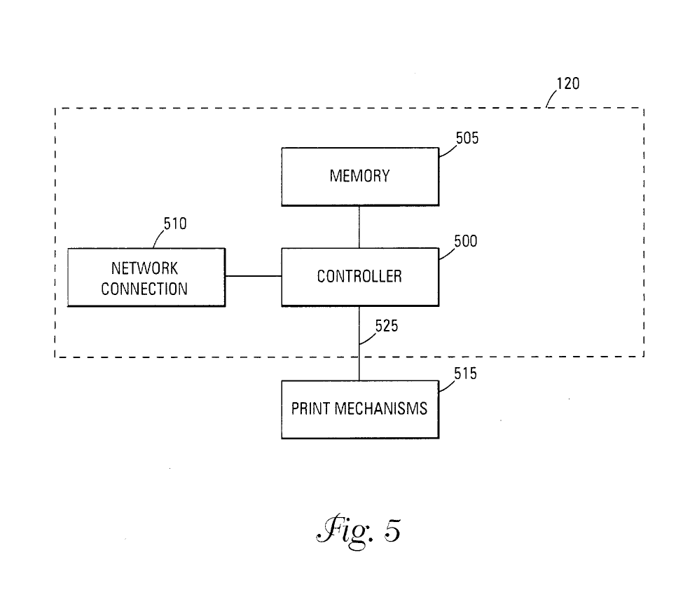

The control circuitry (120) is responsible for controlling the various functions of the tester print head as well as the normal operation of a functional print head. The control circuitry (120) executes the embodiments of the self-test method of the present invention. This circuitry (120) is discussed subsequently in greater detail with reference to FIG. 5.

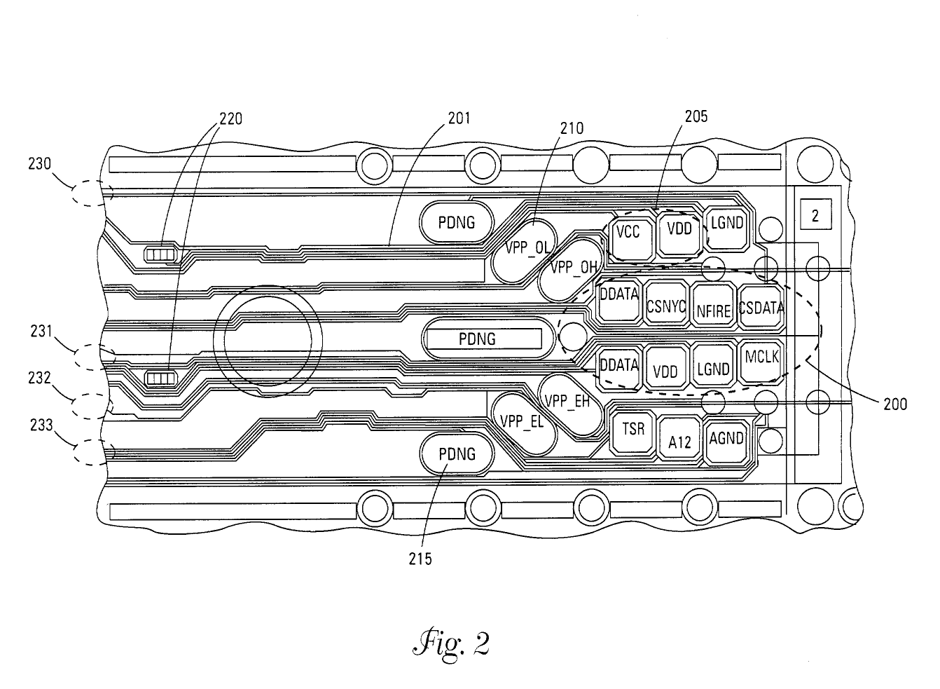

FIG. 2 illustrates a circuit diagram of one embodiment of the circuitry of the tester print head of the present invention. The circuitry is comprised of a conductive material that enables the control circuitry illustrated in FIG. 1 to communicate with the tester print head.

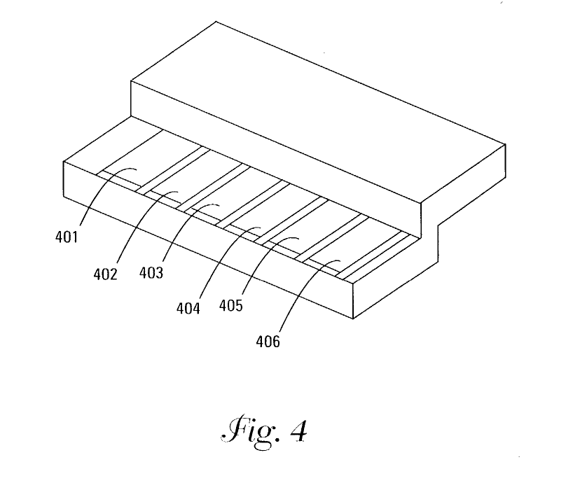

The circuitry of the embodiment of FIG. 2 is comprised of multiple data logic pads (200) and power and ground pads (205 and 215) that mirror the pads used in a functional print head. Various additional pads may be provided (e.g., additional power/ground and control) (215 and 210) depending on the embodiment. When the tester print head is inserted into a printer carriage assembly, these pads are coupled to interconnect pins in the carriage assembly. The interconnect pins are coupled to the control circuitry of the printer through cables and other linking hardware. As is well known in the art, the carriage assembly is the mechanism that holds a print head in a printer. The carriage assembly is discussed subsequently with reference to FIG. 4.

The circuitry additionally includes capacitors (220) and traces (201) that connect the pads (200, 205, 210, 215) to status return pads (230-233) that provide the feedback path back to the control circuitry in the printer. For example, in one embodiment, the printer control circuitry sends a logic high signal (e.g., +5V) through the linking hardware to the MCLK pad of the data logic pads (200). This pad is connected by one or more traces (201) to one or more return status pads (230-233) that are connected through the linking hardware to the printer control circuitry.

In one embodiment, all of the data and power pads are coupled to a single return status pad for connection to the printer control circuitry. In this embodiment, the control circuitry cycles through each of the linking hardware individually during the self-test mode and applies a self-test signal (e.g., +5V) to each line. The status return line is then checked for a return of the same signal. If the signal that was sent is on the status return line, the tested linking hardware is considered good and the next connection may be checked. In another embodiment, the status return line is grounded and the control circuitry checks for current flow or other continuity check to determine continuity. This continuity check may be performed in parallel.

In another embodiment, each of the data and power pads are coupled to a separate return status pad for connection to the printer control circuitry. In this embodiment, the control circuitry can apply a self-test signal to each of the data and power pads substantially simultaneously while checking the return status pads for the returned signal. This embodiment has the advantage of being faster than a single return status pad.

The return status pads are located on the tester print head in the same locations as any return pads on a functional print head. For example, a functional print head is capable of returning ink reservoir status to the printer. The location of this return pad may be used in one embodiment of the tester print head.

Alternate embodiments use other self-test signals than +5V. For example, a clock signal with a predetermined periodic frequency can be used. If the tester print head embodiment includes circuitry that accepts and generates digital data, the self-test signal may be a self-test word to which the tester print head would reply with a status word, depending on the state of the linking hardware. The embodiments of the present invention are not limited to any one test signal.

A functional ink jet print head typically incorporates flexible microcircuits for this circuitry in order to keep down the cost of each print head. The flexible circuitry is more susceptible to failure due to its flexing nature. However, the circuitry in one embodiment of the tester print head of the present invention incorporates larger and more robust circuitry and interconnect pads. This can be done because the cost of each tester print head is less of an issue when a user only needs to purchase one tester print head over the life of the printer.

The embodiment of the tester print head circuitry illustrated in FIG. 2 is for purposes of illustration only. This circuitry varies for each type of printer and each type of print head that is replaced by the tester print head of the present invention.

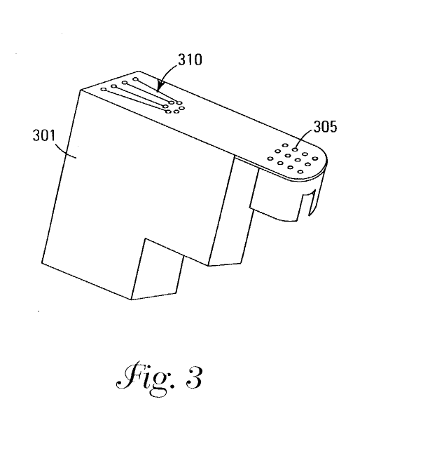

FIG. 3 illustrates a perspective view of one embodiment of the tester print head of the present invention. This embodiment includes a main body section (301), circuit traces (310), and a non-functioning print head section (305). The shape and location of the elements of the tester print head are substantially similar to a functioning print head that would contain ink. This permits the tester print head to fit into the carriage in the same way as a functioning print head.

A functioning print head typically includes a keying element that only permits the print head to be positioned in the carriage in the proper color slot. In one embodiment, the tester print head does not include this keying function, thus allowing it to replace any of the functioning print heads in any of the carriage slots. In an alternate embodiment, the tester print head includes the keying function.

FIG. 4 illustrates a perspective view of a carriage assembly in accordance with one embodiment of the present invention. The carriage assembly is the part of the printer into which the tester print head is inserted. The assembly includes multiple slots (401-406) that accept either functioning print heads having different ink color or the tester print head. Each slot (401-406) contains the interconnect pins that mate with the pads on the tester print head circuitry. This enables the printer controller to communicate with each slot (401-406) individually during the self-test mode.

In a normal function mode, the carriage assembly moves across print media to move the functioning print heads to the proper locations for whatever image is to be drawn. In one embodiment of a self-test mode, the carriage is stationary while the testing function is performed. In an alternate embodiment, the carriage moves in a normal manner.

FIG. 5 illustrates a block diagram of one embodiment of a printer of the present invention. The printer is comprised of a controller (500) that controls the operation of the printer. The controller (500) may be a microprocessor or it may be a simpler microcontroller running microcode.

The printer memory (505) may be of the type used for temporary storage of data such as random access memory (RAM). Additionally, the memory (505) may be of the type used for permanent storage of data such as read only memory (ROM), programmable read only memory (PROM), and/or memory cards. Other types of memory, semiconductor, magnetic, optical, or other types, can be included as memory.

The printer memory (505) can store self-test data and self-test results. The memory can also store tasks to be executed by the printer controller (500) during the idle time that the controller (500) is not executing a print job.

The network connections (510) include any network interface cards (e.g., Ethernet) required to interface the printer to a network. In another embodiment, the network connection (510) is simply a USB port, IEEE 1394 port (FIREWIRE), infrared, or other type of port for coupling the printer to a computer.

The controller (500) is also coupled to and controls the printer mechanisms (515) of the printer. In the embodiments of the present invention, the printer mechanisms (515) include the tester print head(s), any functional inkjet print head(s), the print head carriage assembly, and the roller that feeds the print media through the printer.

The controller (500) is coupled to the print mechanisms (515) through linking hardware (525). The linking hardware (525) includes the cables, wireless connections, and other interconnection devices required to connect the control circuitry (120) to the print mechanisms (515).

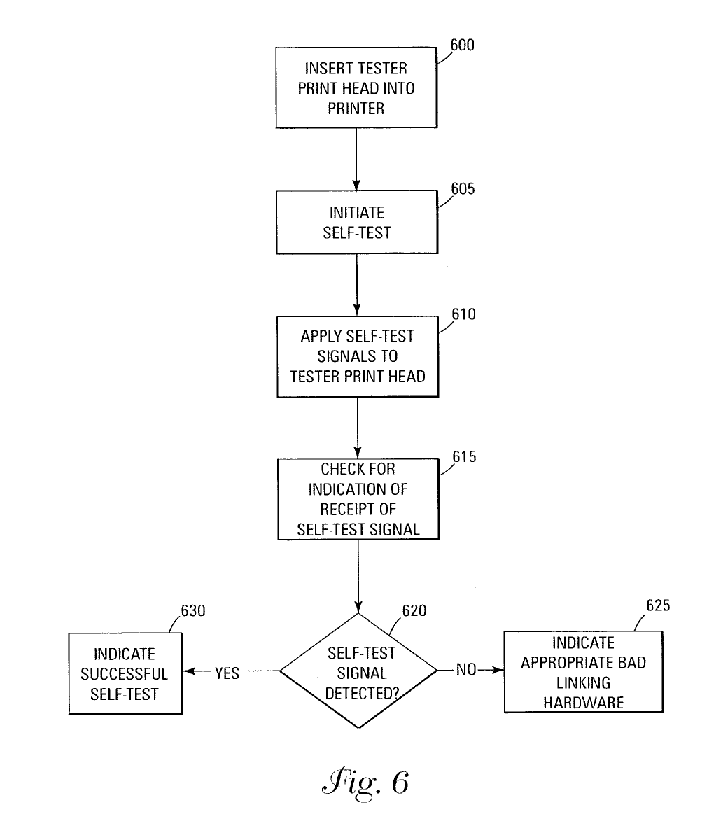

FIG. 6 illustrates a flowchart of one embodiment of a self-test method of the present invention. The tester print head is initially inserted into a print head slot of the printer (600). In one embodiment, the tester print head is inserted into the carriage assembly.

Self-test mode is then initiated (605). This can be accomplished by a computer that is connected to the printer through a bus or network connection. The self-test mode can also be initiated by depressing a key or a predetermined sequence of keys on the printer as illustrated in FIG. 6. In another embodiment, the self-test is initiated by the insertion of the tester print head into the printer. In this embodiment, the printer firmware detects the insertion and initiates self-test.

The self-test signal or signals are applied to the tester print head (610). In one embodiment, these signals are generated and transmitted to the tester print head by the control circuitry of the printer. As discussed previously, the type and quantity of test signal(s) may be different for different embodiments of the tester print head.

The return status lines are then checked for an indication that the tester print head received the self-test signal(s) (615). Depending on the embodiment, the return status lines might be checked for continuity, the return of a manipulated signal indicating continuity, or simply current flow if the status return lines are grounded. In one embodiment, this checking is accomplished by the printer control circuitry. If an indication of the self-test signal(s) is detected (620), the linking hardware is present and operating properly. An indication of successful self-test is made on a printer display, computer screen, or an aural tone. In this case, if there is a printing problem, the problem may be with the print head that the tester print head has replaced. The user can then replace the defective print head without calling an expensive maintenance technician for assistance.

If an indication of the self-test signal(s) is not detected (615), this is an indication that the functional print head replaced by the tester print head is probably not defective. The indication is made to the user (625) through a self-test result display on a printer display, computer screen, or an aural tone. In such a situation, the user can then call the maintenance technician to service the printer. In an alternate embodiment, if the printer is coupled to the Internet, the printer can send a request automatically to the servicing company for assistance with the printer.

### CONCLUSION

The printer with the diagnostic print head of the present invention provides a printer user with the capability for performing self-diagnostic tests prior to or in place of a maintenance service call by the printer manufacturer. This enables the printer user to detect simple problems (e.g., defective print head), thereby reducing printer down time and maintenance costs incurred by both the manufacturer and the user.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A tester print head for insertion into a printer, the tester print head comprising:
a conductive pad capable of accepting a self-test signal from the printer, the conductive pad coupling the tester print head to the printer through linking hardware;
a return status pad capable of providing an indication of continuity of the linking hardware to the printer; and
a feedback path that couples the conductive pad to the return status pad.

2. The tester print head of claim 1 wherein the tester print head is adapted for insertion into a carriage assembly that holds the tester print head in the printer.

3. The tester print head of claim 2 wherein the conductive pad and the return status pad are comprised of a conductive material that is coupled to interconnect pins in the carriage assembly upon insertion of the tester print head into the carriage assembly.

4. The tester print head of claim 1 wherein the feedback path is comprised of a circuit trace of conductive material.

5. The tester printer head of claim 1 wherein the self-test signal is a predetermined voltage level.

6. A tester print head for insertion into a printer, the tester print head comprising:
a plurality of conductive pads each capable of accepting a self-test signal from the printer, the plurality of conductive pads coupling the tester print head to the printer through linking hardware;
a return status pad capable of providing an indication of continuity of the linking hardware to the printer; and
a feedback path that couples the plurality of conductive pads to the return status pad.

7. The tester print head of claim 6 wherein the self-test signal is a periodic signal having a predetermined frequency.

8. The tester print head of claim 6 wherein the tester print head is coupled to a control circuit in the printer that generates the self-test signal.

9. The tester print head of claim 8 wherein the linking hardware comprises cables and connections that couple the tester print head to the control circuit.

10. The tester print head of claim 8 wherein the linking hardware comprises a wireless link that couples the tester print head to the control circuit.

11. A tester print head for insertion into a printer, the tester print head comprising:
a plurality of conductive pads each capable of accepting a self-test signal of a plurality of self-test signals from the printer, the plurality of conductive pads coupling the tester print head to the printer through linking hardware;
a plurality of return status pads each capable of providing an indication of continuity of the linking hardware to the printer; and
a plurality of feedback paths that each couple a different conductive pad of the plurality of conductive pads to a different return status pad of the plurality of return status pads.

12. The tester print head of claim 11 wherein a first self-test signal of the plurality of self-test signals coupled to a first conductive pad of the plurality of conductive pads is different than a second self-test signal coupled to a second conductive pad.

13. The tester print head of claim 11 wherein a control circuit in the printer generates the plurality of self-test signals and receives the self-test signals in response to the status of the linking hardware.

14. A printer having self-test capabilities comprising:
a control circuit that generates a self-test signal; and
a tester print head that is inserted into the printer, the tester print head comprising:
a conductive pad capable of accepting a self-test signal from a control circuit of the printer, the conductive pad coupling the tester print head to the printer through linking hardware;
a return status pad capable of providing an indication of continuity of the linking hardware to the control circuit; and
a feedback path that couples the conductive pad to the return status pad.

15. The printer of claim 14 and further including a carriage assembly capable of receiving the tester print head such that the conductive pad and the return pad are coupled to interconnect pins in the carriage assembly.

16. A method for performing a printer self-test comprising:
initiating the printer self-test;
generating a self-test signal for application to a tester print head that is inserted in the printer;
checking for an indication of receipt of the self-test signal by the tester print head;
if the indication is not detected, indicating that the self-test failed; and
if the indication is detected, indicating that the self-test passed.

17. The method of claim 16 wherein initiating the printer self-test comprises connecting the tester print head to a carriage assembly of the printer.

18. The method of claim 16 wherein generating the self-test signal comprises generating a signal having a predetermined frequency.

19. The method of claim 17 wherein the self-test signal tests the connection of the tester print head to the printer through linking hardware.

20. The method of claim 19 wherein indicating that the self-test passed indicates continuity in the linking hardware.

21. The method of claim 16 wherein checking for the indication includes checking for current flow through a status return line.

22. The method of claim 16 wherein checking for the indication includes checking for return of a manipulated self-test signal indicating continuity.
